(19) United States
(12) Patent Application Publication
(10) Pub. No.: US 2011/0012789 A1
(43) Pub. Date: Jan. 20, 2011

(54) Multi-Band Antenna

(76) Inventors: Wen-Chieh Yang, Taipei (TW); Kai Shih, Taipei (TW); Yu-Yuan Wu, Taipei (TW)

Correspondence Address: Lin & Associates;Intellectual Property, Inc., PO Box 2339, Saratoga, CA, 95070-0339, US

(21) Appl. No.: 12/505,469

(22) Filed: Jul. 18, 2009

(51) Int. Cl. H01Q 1/36

(52) U.S. Cl. 343/700 MS; 343/845

(57) ABSTRACT

A multi-band antenna has a ground portion, a first radiating portion defining opposite first and second ends, a L-shaped radiating portion connected to the second end of the first radiating portion and defining a third end extending towards the ground portion and a fourth end extending towards a direction, a stair-shaped radiating portion located between the ground portion and the L-shaped radiating portion and defining a fifth end connected to the first end of the first radiating portion and a sixth end extending towards the direction, and having at least one bent section, which has at least one bent section, a connecting portion interconnecting the bent section of the fourth radiating portion and the ground portion, and a feeding point arranged at the first end of the first radiating portion.

### BACKGROUND OF THE INVENTION

1. Field of the Invention

The present invention relates to an antenna, more specifically, an antenna capable of receiving and transmitting various frequency bands at the same time.

2. The Related Art

With the progress of broadcasting information and electronic technology, the technology of electronic products such as computers, mobile phones and network communication products is rapidly developed. Hence, the electronic products have the advantages of compact size, low price and multiple functions.

Especially, network communication products are popularly used in daily life and at various spaces, such as office, home, automobile, etc. And therefore improves the convenience of information communication. Because various network communication products are rapidly upgraded in marketing, the requests for advanced functions of the network communication products are increased. Hence, combining various functions and services of convenience and efficiency are important appraisals for the network communication products.

With the rapid progress of the portable communication products, antenna products are aimed by electronic component manufacturers. Due to the antennas capable of transferring current into radio wave and transferring radio wave into current, it is a major component in communication system. Thus, the efficiency and the gain of the antenna may directly affect the quality of transmitted data in the communication system. Hence, the electronic component manufacturers spend a lot of time and money to improve the efficiency and the gain of the antenna in order to improve quality and sale quantity of the portable communication products.

Institute of Electrical and Electronic Engineer (IEEE) 802.11a/b/g and 802.16e are general standards of wireless local area network nowadays. IEEE 802.11a operates at 5.2 GHz band (5.15 GHz to 5.875 GHz). IEEE 802.11b/g operates at 2.4 GHz band (2.412 GHz to 2.462 GHz). IEEE 802.16e operates about 2 GHz to 6 GHz. Frequency bands covering 2.6 GHz and 3.5 GHz are two channels in IEEE 802.16e standard.

In order to improve the feature of compatibility, the antenna configured in the portable communication products is capable of receiving and transmitting signals carried through at least two wireless local area network frequency bands for conforming IEEE standards mentioned above. Hence, the antenna operated at least two wireless local area network frequency bands becomes an essential component of the portable communication products.

The antenna has the external type and the embedded type. Generally speaking, the embedded antenna is more preferable than the external antenna for the portable communication products owing to the mechanical and ergonomic reasons. The embedded antenna is protected by the portable communication products case or housing and therefore tend to be more durable than external antenna.

A conventional antenna is disclosed at Taiwan patent M329873. The conventional antenna includes a grounding element having a first side, a radiating element separated from the first side of the grounding element, and a connecting element. The radiating element has a first radiating section and a second radiating section. The connecting element connects the grounding element to the radiating element and includes a first end slantwise extending from the grounding element to form a first angle except a right angle between the connecting element and the grounding element.

The first radiating section of the radiating element can receive and transmit signals carried through a higher band covering 5.2 GHz. The second radiating section of the radiating element can receive and transmit signals carried through a lower band covering 2.4 GHz. Hence, the conventional antenna can operate at IEEE 802.11a/b/g standard.

However, the conventional antenna operated according to IEEE 802.11 standard can not be operated at IEEE 802.16e standard covering 2.6 GHz and 3.5 GHz at the same time.

### SUMMARY OF THE INVENTION

An object of the present invention is to provide a multi-band antenna capable of operating with various wireless local area network frequency bands.

According to the invention, the multi-band antenna has a feeding point, a ground portion, a first radiating portion, a second radiating portion, a third radiating portion, a fourth radiating portion and a connecting portion. The ground portion extends in a first direction. The first radiating portion extends in a second direction perpendicular to the first direction and defines a first end close to the ground portion, a second end opposite to the first end, a first side and a second side opposite to the first side.

The second radiating portion extends from the first side of the second end of the first radiating portion. The third radiating portion extends in the first direction and from the second side of the second end of the first radiating portion. The fourth radiating portion extends from the second side of the first end of the first radiating portion and is located between the ground portion and the third radiating portion. The connecting portion interconnects the ground portion and the fourth radiating portion. The feeding point is located at the first end of the first radiating portion.

The feeding point, the ground portion, the first radiating portion, the second radiating portion, a part of the fourth radiating portion, and the connecting portion are formed as a first Inverted-F antenna which resonates at a first band covering 5.2 GHz corresponding to IEEE 802.11a.

The feeding point, the ground portion, the first radiating portion, the third radiating portion, the part of the fourth radiating portion, and the connecting portion are formed as a second Inverted-F antenna which resonates at a second band covering 2.4 GHz and 2.6 GHz corresponding to IEEE 802.11b/g and IEEE 802.16e respectively.

The feeding point, the ground portion, the fourth radiating portion, and the connecting portion are formed as a third Inverted-F antenna which resonates at a third band covering 3.5 GHz corresponding to IEEE 802.16e. Therefore, the multi-band antenna can be operated at various wireless local area network frequency bands at the same time.

### BRIEF DESCRIPTION OF THE DRAWINGS

The present invention will be apparent to those skilled in the art by reading the following description of preferred embodiments thereof, with reference to the attached drawings, in which:

FIG. 1 shows a first preferred embodiment of a multi-band antenna according to the present invention;

FIG. 2 shows a second preferred embodiment of the multi-band antenna according to the present invention; and

FIG. 3 shows a Voltage Standing Wave Ratio (VSWR) test chart of the multi-band antenna according to the present invention.

### DETAILED DESCRIPTION OF THE PREFERRED EMBODIMENT

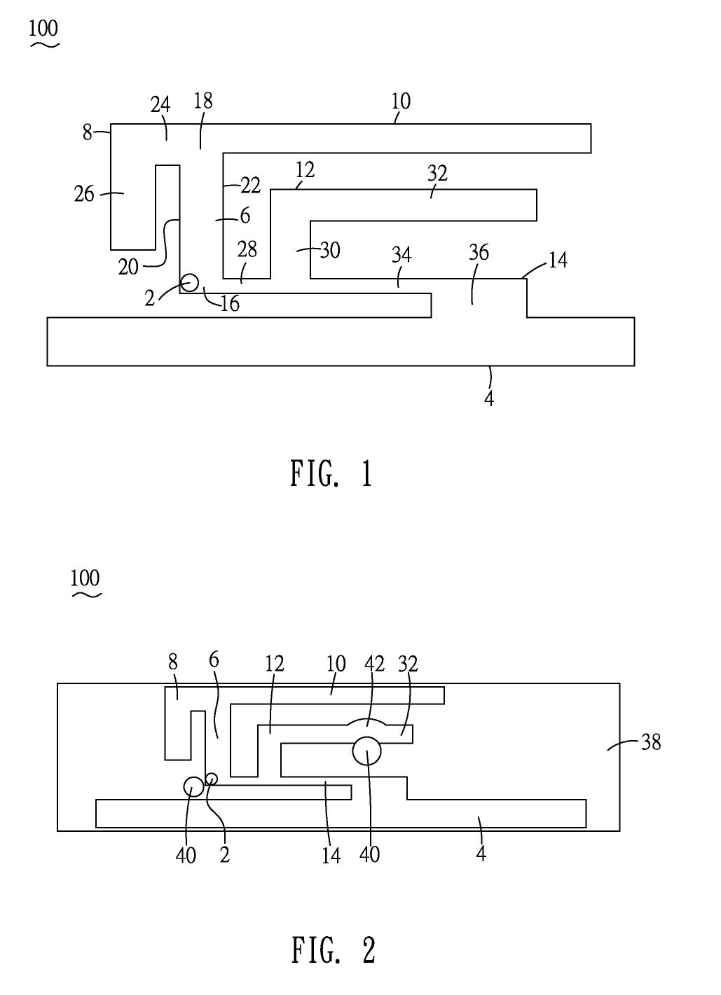

Please refer to FIG. 1. A first preferred embodiment of a multi-band antenna 100 is made of a metal foil. The multi-band antenna 100 has a feeding point 2, a ground point 4, a first radiating portion 6, a second radiating portion 8, a third radiating portion 10, a fourth radiating portion 12 and a connecting portion 14.

The first radiating portion 6, the second radiating portion 8, the third radiating portion 10, the fourth radiating portion 12 and the connecting portion 14 are arranged at one side of the ground portion 4. The ground portion 4 is of a rectangular shape and extends in a first direction. The first radiating portion 6 is of a rectangular shape and extends in a second direction perpendicular to the first direction.

The first radiating portion 6 defines opposite first end 16 and second end 18, and opposite first side 20 and second side 22. The first end 16 of the first radiating portion 6 is close to the ground portion 4. The feeding point 2 is located at the first end 16 of the first radiating portion 6.

The second radiating portion 8 extends from the first side 20 of the second end 18 of first radiating portion 6 and has a first radiating section 24 and a second radiating section 26. One end of the first radiating section 24 connects to the first side 20 of the second end 18 of the first radiating portion 6, and the other end of the first radiating section 24 connects to the second radiating section 26.

Especially, the first radiating section 24 of the second radiating portion 8 extends in the first direction, and the second radiating section 26 extends in the second direction. The second radiating section 26 of the second radiating portion 8 is arranged to face to and close to the first radiating portion 6. The free end of the second radiating section 26 is towards the ground portion 4. The second radiating portion 8 is of a L shape. The second radiating portion 8 and the third radiating portion 10 are together formed as a L-shape.

The third radiating portion 10 extends from the second side 22 of the second end 18 of the first radiating portion 6 and extends in the first direction. The third radiating portion 10, the first radiating section 24 of the second radiating portion 8 and the second end 18 of the first radiating portion 6 are substantially at the same level. The fourth radiating portion 12 extends from the second side 22 of the first end 16 of the first radiating portion 6, and is arranged between the ground portion 4 and the third radiating portion 10.

The fourth radiating portion 12 has a third radiating section 28, a fourth radiating section 30 and a fifth radiating section 32. The third radiating section 28 of the fourth radiating portion 10 extends in the first direction. The third radiating section 28 of the fourth radiating portion 10 is close to the ground portion 4. One end of the third radiating section 28 connects to the second side 22 of the first end 16 of the first radiating portion 6, and the other end of the third radiating section 28 connects to the fourth radiating section 30.

The fourth radiating section 30 extends in the second direction, and is arranged to face to and close to the first radiating portion 6. The fourth radiating section 30 interconnects the third radiating section 28 and the fifth radiating section 32. The fifth radiating section 32 extends in the first direction. The free end of the third radiating portion 10 and the free end of the fifth radiating section 32 are towards the same direction. Especially, the fourth radiating portion 12 is of a stair shape.

The connecting portion 14 interconnects the fourth radiating portion 12 and the ground portion 4. The connecting portion 14 has a first section 34 and a second section 26. One end of the first section 34 of the connecting portion 14 connects to a corner defined by the third radiating section 28 and the fourth radiating section 30 of the fourth radiating portion 12. The second section 36 interconnects the other end of the first section 34 and the ground portion 4.

Especially, the first section 34 extends in the first direction, and the second section 36 extends in the second direction. The first section 34 of the connecting portion 14 and the third radiating section 28 of the fourth radiating portion 12 are substantially at the same level. The first section 34 is close to the ground portion 4. The connecting portion 14 is of a L shape.

Especially, the ground portion 4, the first radiating portion 6, the second radiating portion 8, the third radiating portion 10, the fourth radiating portion 12 and the first section 34 of the connecting portion 14 are of an elongate shape. The second section 36 of the connecting portion 14 is of a rectangular shape.

Please refer to FIG. 2. A second embodiment of a multi-band antenna 100 is printed on a circuit board 38, such as a printed circuit board or a flex printed board. In this case, the ground portion 4, the first radiating portion 6, the second radiating portion 8, the third radiating portion 10, the fourth radiating portion 12 and the connecting portion 14 are printed on one surface of the circuit board 38.

Especially, the circuit board has plurality of through hole 40. The fifth radiating section 32 of the fourth radiating portion has a curve 42 for avoiding the through hole 40. The through hole 40 can engage with a corresponding engaging element for fixing the circuit board 38 to an electric device.

The feeding point 2, the ground portion 4, the first radiating portion 6, the second radiating portion 8, the third radiating section 28 of the fourth radiating portion 12, and the connecting portion 14 are formed as a first Inverted-F antenna. The cooperation of them resonates at a first band covering 5.2 GHz. The electronic length of the first radiating portion 6 and the second radiating portion 8 is a quarter wavelength corresponding to the first band.

The feeding point 2, the ground portion 4, the first radiating portion 6, the third radiating portion 10, the third radiating section 28 of the fourth radiating portion 12, and the connecting portion 14 are formed as a second Inverted-F antenna. The cooperation of them resonates at a second band covering 2.4 GHz and 2.6 GHz. The electronic length of the first radiating portion 6 and the third radiating portion 10 is a quarter wavelength corresponding to the second band. In the case of the first Inverted-F antenna and the second Inverted-F antenna, the third radiating section 28 of the fourth radiating portion 10 functions as a part of the connecting portion 14.

The feeding point 2, the ground portion 4, the fourth radiating portion 12, and the connecting portion 14 are formed as a third Inverted-F antenna. The cooperation of them resonates at a third band covering 3.5 GHz. The electronic length of the fourth radiating portion 12 is a quarter wavelength corresponding to the third band.

The connecting portion 14 functions as an inductance for tuning bandwidth of the second band, antenna matching and impedance. If the length of the connecting portion 14 is increased, then the value of the inductance will be therefore increased. Hence, the bandwidth of the second band is enhanced.

The location of the fifth radiating section 32 of the fourth radiating portion 12 is related to the antenna gain of the second band and the third band. If the fifth radiating section 32 of the fourth radiating portion 12 is close to the third radiating portion 10, then the Voltage Standing Wave Ratio (VSWR) of the second band will be raised, and the VSWR of the third band will be decreased. If the fifth radiating section 32 of the fourth radiating portion 12 is close to the ground portion 4, then the Voltage Standing Wave Ratio (VSWR) of the second band will be decreased, and the VSWR of the third band will be raised.

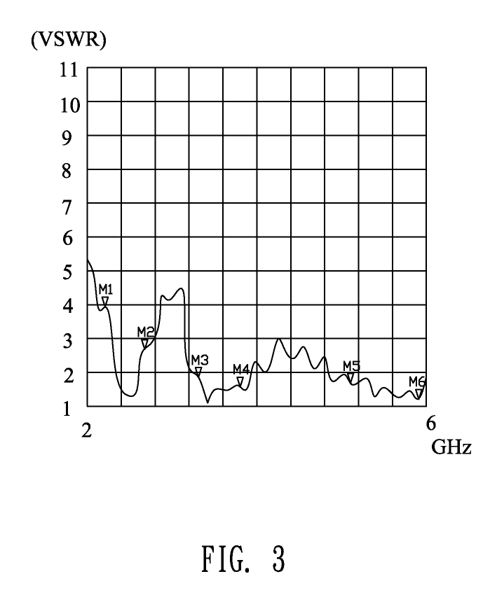

Please refer to FIG. 3, it shows a VSWR test chart of the multi-band antenna 100. If the multi-band antenna 100 operates at 2.3 GHz, then the VSWR value will be 2.8497 (M1 in FIG. 3). If the multi-band antenna 100 operates at 2.7 GHz, then the VSWR value will be 2.6221 (M2 in FIG. 3). Therefore, the multi-band antenna 100 can stably operate at the second band covering 2.4 GHz corresponding to IEEE 802.11b/g and 2.6 GHz corresponding to IEEE 802.16e.

If the multi-band antenna 100 operates at 3.3 GHz, then the VSWR value will be 1.8931 (M3 in FIG. 3). If the multi-band antenna 100 operates at 3.8 GHz, then the VSWR value will be 1.464 (M4 in FIG. 3). Therefore, the multi-band antenna 100 can stably operate at the third band covering 3.5 GHz corresponding to IEEE 802.16e.

If the multi-band antenna 100 operates at 5.15 GHz, then the VSWR value will be 1.6213 (M5 in FIG. 3). If the multi-band antenna 100 operates at 5.85 GHz, then the VSWR value will be 1.1057 (M6 in FIG. 3). Therefore, the multi-band antenna 100 can stably operate at the first band covering 5.2 GHz corresponding to IEEE 802.11a.

Therefore, the multi-band antenna 100 can operate at the first band covering 5.2 GHz corresponding IEEE 802.11a, the second band covering 2.4 GHz and 2.6 GHz corresponding IEEE 802.11b/g and IEEE 802.16e respectively, and the third band covering 3.5 GHz corresponding IEEE 802.16e.

Furthermore, the present invention is not limited to the embodiments described above; diverse additions, alterations and the like may be made within the scope of the present invention by a person skilled in the art. For example, respective embodiments may be appropriately combined.

What is claimed is:

1. A multi-band antenna, comprising:
a ground portion extending in a first direction;
a first radiating portion extending in a second direction perpendicular to the first direction and defining a first end close to the ground portion, a second end opposite to the first end, a first side and a second side opposite to the first side;
a second radiating portion extending from the first side of the second end of the first radiating portion;
a third radiating portion extending in the first direction and from the second side of the second end of the first radiating portion;
a fourth radiating portion extending from the second side of the first end of the first radiating portion and located between the ground portion and the third radiating portion;
a connecting portion interconnecting the ground portion and the fourth radiating portion; and
a feeding point located at the first end of the first radiating portion.

2. The multi-band antenna as claimed in claim 1, wherein the third radiating portion is of an elongated shape.

3. The multi-band antenna as claimed in claim 1, wherein the second radiating portion has a first radiating section and a second radiating section, one end of the first radiating section connects to the first side of the second end of the first radiating portion, and the other end of the first radiating section connects to one end of the second radiating section, the other end of the second radiating section is a free end and is arranged towards the ground portion.

4. The multi-band antenna as claimed in claim 3, wherein the first radiating section of the second radiating portion extends in the first direction and the second radiating section of the second radiating portion extends in the second direction.

5. The multi-band antenna as claimed in claim 4, wherein the second radiating section of the second radiating portion is arranged to face to and close to the first radiating portion.

6. The multi-band antenna as claimed in claim 1, wherein the fourth radiating portion has a third radiating section, a fourth radiating section and a fifth radiating section, one end of the third radiating section connects to the second side of the first end of the first radiating portion, the fourth radiating section interconnects the other end of the third radiating section and one end of the fifth radiating section, the other end of the fifth radiating section is a free end, the connecting portion interconnects the ground portion and a corner defined between the third radiating section and the fourth radiating section.

7. The multi-band antenna as claimed in claim 6, wherein the third radiating section and the fifth radiating section extend in the first direction, the fourth radiating section extends in the second direction.

8. The multi-band as claimed in claim 7, wherein the third radiating section is close to the ground portion, the fourth radiating section is close to the first radiating portion, the free end of the third radiating portion and the free end of the fifth radiating section extend towards the same direction.

9. The multi-band antenna as claimed in claim 8, wherein the connecting portion has a first section and a section, one end of the first section connects to the corner defined between the third radiating section and the fourth radiating section, the section interconnects the other end of the first section and the ground portion.

10. The multi-band antenna as claimed in claim 9, wherein the first section extends in the first direction, the first section of the connecting portion and the third radiating section of the fourth radiating portion are at the same level.

11. The multi-band antenna as claimed in claim 1, wherein the ground portion, the first radiating portion, the second radiating portion, the fourth radiating portion and the connecting portion are printed on a circuit board.

12. The multi-band antenna as claimed in claim 11, wherein the circuit board has at least one through hole.

13. A multi-band antenna, comprising:
a ground portion;
a first radiating portion defining opposite first side and second side, and opposite first end and second end, the first end being close to the ground portion;
a second radiating portion extending from the first side of the second end of the first radiating portion;
a third radiating portion extending from the second side of the second end of the first radiating portion and in a second direction;
a fourth radiating portion extending from the second side of the first end of the first radiating portion and having a first bent portion, which is arranged between the third radiating portion and the ground portion;
a connecting portion interconnecting the first bent portion of the fourth radiating portion and the ground portion; and
a feeding point arranged at the first end of the first radiating portion.

14. The multi-band antenna as claimed in claim 13, wherein the first radiating portion extends in a first direction, the third radiating portion extends in a second radiating direction perpendicular to the first radiating portion, the second radiating portion has a first radiating section arranged in the second radiating direction and a second radiating section arranged in the first radiating direction, the first radiating section interconnecting the first side of the second end of the first radiating portion and the second radiating section.

15. The multi-band antenna as claimed in claim 14, wherein the second end of the first radiating portion, the first radiating section of the second radiating portion and the third radiating portion are substantially at the same level, the second radiating section is close to the first radiating portion, the free end of the second radiating section extends towards the ground portion.

16. The multi-band antenna as claimed in claim 13, wherein the fourth radiating portion further has a second bent portion, the fourth radiating portion is divided into a third radiating section extending in the second direction, a fourth radiating section extending in the first direction and a fifth radiating section extending in the second direction by the first bent portion and a second bent portion, the third radiating section interconnects the second side of the first end of the first radiating portion and the fourth radiating section, the fourth radiating section interconnects the third radiating section and the fifth radiating section.

17. The multi-band antenna as claimed in claim 16, wherein the third radiating section is close to the ground portion, the fourth section is close to and face to the first radiating portion, the free end of the third radiating portion and the free end of the fifth radiating section of the fourth radiating portion extend towards the same direction.

18. The multi-band antenna as claimed in claim 17, wherein the connecting portion has a first section extending in the second direction and a second section, the first section interconnects the first bent portion of the fourth radiating portion and the second section, the second section interconnects the first section and the ground portion, the first section of the connecting portion and the third radiating section of the fourth radiating portion are at the same level.

19. A multi-band antenna, comprising:
a ground portion;
a first radiating portion defining opposite first end and second end;
a L-shaped radiating portion connected to the second end of the first radiating portion and having a third end extending towards the ground portion and a fourth end extending towards a direction;
a stair-shaped radiating portion located between the ground portion and the L-shaped radiating portion and defining a fifth end connected to the first end of the radiating portion and a sixth end extending towards the direction, which has at least one bent section;
a connecting portion interconnecting the bent section of the fourth radiating portion and the ground portion; and
a feeding point arranged at the first end of the first radiating portion.

20. The multi-band antenna as claimed in claim 19, wherein the connecting portion is of a L shape.
